(19) United States
(12) Patent Application Publication
(10) Pub. No.: US 2007/0125369 A1
(43) Pub. Date: Jun. 7, 2007

(54) Process for converting anhydrosugars to glucose and other fermentable sugars

(76) Inventors: Edwin S. Olson, Grand Forks, ND (US); Barry Freel, Greely (CA)

Correspondence Address: JOHNSON & ASSOCIATES, PO BOX 90698, AUSTIN, TX, 78709-0698, US

(21) Appl. No.: 11/349,744

(22) Filed: Feb. 7, 2006

Related U.S. Application Data
(60) Provisional application No. 60/650,461, filed on Feb. 7, 2005.

(51) Int. Cl. C13K 1/02

(52) U.S. Cl. 127/37

(57) ABSTRACT

A process is provided for producing glucose and other fermentable sugars from a liquid mixture containing anhydrosugars. One example of a process encompasses: 1) water extraction of a anhydrosugar-rich fast-pyrolysis bio-oil fraction that constitutes a residual after removal of volatile impurities, 2) further purification of said anhydrosugar-rich fraction, and 3) solid-phase catalytic hydrolysis of the anhydrosugars to yield glucose and other fermentable sugars. An exemplary application of the process is in the production of ethanol and other sugar-based fermentation products from bio-oil generated via fast pyrolysis of low-cost, high-availability lignocellulosic biomass resources.

### CROSS REFERENCE TO RELATED APPLICATIONS

This application claims priority under 35 U.S.C. § 119/120 to co-pending, commonly owned U.S. provisional patent application Ser. No. 60/650,461 filed on Feb. 2, 2005, entitled “PROCESS FOR CONVERTING ANHYDROSUGARS TO GLUCOSE AND OTHER FERMENTABLE SUGARS”, which is incorporated by reference herein.

This invention was made with Government support under US Department of Agriculture, National Alternative Fuels Laboratory®, Phase 12, Agreement No. 2002-38819-01906 and Phase 15, 2005-38819-02311 awarded by the United States Department of Agriculture. The Government has certain rights in the invention.

### FIELD OF THE INVENTION

The present invention comprises a process by which glucose and other fermentable sugars are produced from a liquid mixture containing anhydrosugars. Anhydrosugars are a class of compounds that can be converted to sugars via a catalyzed chemical reaction with water in a process commonly referred to as hydrolysis. The invention was developed as a means of maximizing production of fermentable sugars from a bio-oil generated via fast-pyrolysis of lignocellulosic materials. One example of the process encompasses 1) water extraction of a anhydrosugar-rich fast-pyrolysis bio-oil fraction that constitutes a residual after removal of volatile impurities, 2) further purification of said anhydrosugar-rich fraction, 3) and solid-phase catalytic hydrolysis of the anhydrosugars to yield glucose and other fermentable sugars. One potential application of the process is in the production of ethanol and other sugar-based fermentation products from bio-oil generated via fast pyrolysis of low-cost, high-availability lignocellulosic biomass resources.

### BACKGROUND OF THE INVENTION

The development of commercially viable biobased alternatives to fossil fuel-derived gasoline, polymers, and other products would decrease U.S. dependence on imported oil, improve balance of trade, raise domestic employment, and greatly enhance national security. Today, ethanol produced from corn is used to replace a small portion—slightly over 1%—of U.S. gasoline consumption. The basis of the corn-to-ethanol process is yeast fermentation of glucose and other fermentable six-carbon sugars found in corn starch. Corn starch comprises many sugar molecules linked together in a three-dimensional polymer configuration. Because yeast cannot ferment sugar polymerized as corn starch, enzymes are used to break down corn starch into individual sugar molecules, which can then be accessed by yeast for fermentation.

Because corn is relatively expensive to grow and commands significant value as food, large-scale replacement of gasoline with corn-based ethanol is not economically viable. Replacing gasoline with ethanol in an amount sufficient to make a positive impact on U.S. energy security will require the use of lower-cost, higher-availability feedstocks. Appropriate feedstocks include prairie and other grasses, corn stalks, wheat and rice straws, waste paper, cardboard, and wood, and other low-cost lignocellulosic biomass resources. Although these materials are all significantly cheaper than corn, using them for producing ethanol presents a challenge. Like corn, lignocellulosic feedstocks comprise mainly sugar or saccharide units; however, unlike the sugar in corn, the sugar in lignocellulose is chemically bound in ways that make it much harder to break down, or extract, for fermentation. The enzymes used for extracting sugar from corn starch are ineffective in extracting sugar from lignocellulose. The present invention comprises key components of an effective method for extracting fermentable sugars from lignocellulose.

One way to break down the lignocellulose into simple units is to heat the lignocellulose to high temperatures under controlled conditions. This process is termed pyrolysis, and various equipment has been employed to effect the thermal dissociation. Typically the materials are heated rapidly in an inert gas, which carries off the vaporized products to be collected as a condensate after cooling the stream. The condensate oil (“bio-oil”) from the pyrolysis of lignocellulosic substrates contains considerable amounts of anhydrosugars in addition to many other products derived from the various biomass constituents. The anhydrosugars comprise a variety of mono-, di-, and oligosaccharides containing an additional oxidic ring. One of the largest constituent of this family is anhydroglucose or levoglucosan. See FIG. 1, which shows a diagram of the acid-catalyzed hydrolysis of levogluconsan to glucose. Catalytic addition of water (hydrolysis) as illustrated in FIG. 1, opens the ring in most cases and generates simple sugars, most of which are fermentable.

Bacteria are not able to ferment the anhydrosugars, but ferment the simple sugars to a variety of useful products, including acetic acid, lactic acid, citric acid, and many amino acids. Some yeasts and fungi are able to assimilate at least one of the anhydrosugars, levoglucosan, by conversion to glucose-6-phosphate, which is available to enter the glycolysis pathway and form ethanol.

The University of Waterloo disclosed an alternative fast pyrolysis process (WFPP) that leads to 38-58% yields of anhydrosugars (see Piskorz, J.; Scott, D. S., Radlein, D. in Amer. Chem. Coc. Symposium Series No. 376, Soltes, E. J.; Milne, T. A., eds. Amer. Che,. Soc. Washington, D.C. 1988, 167-178, which is incorporated by reference herein). Some publications (e.g., Prosen, E. M.; Radlein, D.; Piskorz, J.; Scott, D. S.; Legge, R. L. Biotechnol. & Bioeng. 1993, 42, 538-541, which is incorporated by reference herein) reported results for fermentation with these products. For Saccharomyces, the production of ethanol from the pyrolysis product was relatively poor (35% of the yield reported using glucose), and for Candida and Geotrichem, almost no ethanol is produced. Thus, hydrolysis of the anhydrosugars is essential for fermentation to occur. In the Prosen publication, Prosen employed hydrolysis with 2% sulfuric acid to convert the WFPP pyrolysis oil to a hydrolysate that was fermentable by these yeasts. However biomass growth yields from this hydrolysate were relatively small. This can be attributed to inhibitors that are present in the pyrolysis product (pyrolysate) and carried over into the hydrolysate. In addition, the WFPP pyrolysis was an inherently an expensive process, since it also required a prehydrolysis step with 5% sulfuric acid. This made the process uneconomical and unable to be commercialized.

Another pyrolysis process is the patented Rapid Thermal Process (RTP™), which was developed by Ensyn Renewables, Inc., of Boston, Mass. Information on RTP™ conditions and applications is contained in U.S. Pat. Nos. 5,792,340, 5,952,029, 6,555,649, 5,961,786, 6,316,040, and 6,485,841, which are all incorporated by reference herein. RTP™ is commercially employed for fast pyrolysis conversion of woody biomass to a condensate oil for specialty chemical and fuel applications. FIG. 2 is a simplified RTP™ flow diagram. In RTP™, contact of the biomass particles with heated blown sand in a cylindrical reaction vessel produces a very rapid heating rate, resulting in breakdown into vaporous products at a temperature of about 500° C.—much lower than combustion or gasification temperatures. So essentially no combustion occurs in this vessel since air input is minimized. Pyrolysis product vapors exit the reactor with a very short (typically less than 1 second) residence time to minimize secondary breakdown reaction to simple gases. Quick removal of initial pyrolysis products from the heated zone is required to ensure against their destruction in secondary polymerization or decomposition reactions. Condensation in the recovery units generates high yields of a light, pourable bio-oil from biomass. Liquid yields approaching 80% of input biomass weight have been achieved. Small amounts of char and gas are also produced.

Liquid product streams from such pyrolysis processes have complex compositions that need to be separated to make use of the individual constituents. Separation processes are often incomplete, difficult to carry out and, thus, uneconomical. The result is in the case of converting the anhydrosugars into fermentable sugars, that the fermentable sugars have an admixture of inhibitors that interfere with the downstream fermentation process.

The RTP process also generates inhibitors during the pyrolysis; however, the separation units incorporated into the system design described here generate a carbohydrate fraction with low inhibitor concentrations. Thus, a solid acid catalysis unit for hydrolysis is conveniently integrated into the system. It is not obvious that coupling the hydrolysis unit to the separation and purification and RTP processing would have the desired effect of producing a fermentable sugar stream via pyrolysis.

### SUMMARY OF THE INVENTION

The present invention was developed as a means of extracting fermentable sugars from bio-oil generated via fast pyrolysis of lignocellulose materials. Based on Ensyn commercial plant experience, a typical hardwood feedstock will give an RTP™ yield of about 74% bio-oil, 14% char, and 12% gas. RTP™-produced bio-oil is similar to crude oil in viscosity and color, and like crude oil, bio-oil comprises hundreds of individual compounds, many of which have commercial value as chemical feedstocks. Also like crude oil, bio-oil can be further fractionated and refined to yield products with specific properties and characteristics as required for various downstream options. In the present invention, whole bio-oil or a specific fraction from one of the process recovery vessels, FIG. 1, is partitioned into a water soluble phase through the addition of an adequate amount of water. Most of the undesirable phenolic fraction of the bio-oil will be removed from the water soluble phase. Adjustment to the water content of the water soluble phase can be made, if necessary, via evaporation. By subjecting the water soluble phase to a rapid thermal distillation there is a further separation of those chemicals that are inhibitors of the microorganism growth and thus ethanol production. The hot bottom stream from the rapid thermal distillation can either be captured as a whole product or quenched with water or other appropriate chemical to preferentially capture the water soluble anhydrosugar-rich fraction while further reducing inhibitor chemicals.

When the bottom stream is isolated as a whole anhydrosugar-rich stream the material is subjected to a three stage process to produce the fermentable sugar with low inhibitor concentration. An example of this process comprises steps to 1) further purify the fraction, 2) hydrolyze the fraction with a solid acid catalyst.

An example of the initial purification step for the anhydrosugar-rich fraction is a water extraction, which comprises:
1) Combining the bio-oil fraction with room temperature (55° to 80° F.) water in a volumetric water-to-bio-oil proportion ranging from 1:1 to 10:1;
2) Agitating the water-bio-oil combination to effect optimum contact between water and bio-oil molecules;
3) Allowing the water-soluble and water-insoluble layers to separate into two distinct phases;
4) Recovering and filtering the water-soluble (extract) phase containing the anhydrosugars.

Residue from the cold water extraction consists of complex resinous materials and carbohydrates with limited solubility in cold water. Many of these cold water-insoluble carbohydrates can be dissolved in hot water.

To further reduce the concentration of phenolic impurities, the aqueous fraction is subjected to batch or counter-current extraction with a moderately polar organic solvent such as diethyl ether, diisopropyl ether, or MIBK.

The extraction can be performed with hot water to achieve a higher concentration of carbohydrate materials. However, the hot water simultaneously extracts more of the inhibitor species and is less stable in subsequent operations.

In step 2 of the present invention, a bio-oil water extract or another anhydrosugar-containing feedstock is subjected to a solid acid-catalyzed hydrolysis process for conversion of anhydrosugars to glucose and other fermentable sugars. The hydrolysis process can be illustrated using the compound levoglucosan as an example. In work performed to date, water-extracted bio-oil prepared as described above has been shown to contain levoglucosan in high concentrations, along with significant levels of similar anhydrosugars known as anhydromonosaccharides, anhydrodisaccharides and anhydrooligosaccharides. In the hydrolysis reaction (see FIG. 2), protonation of the oxygen attached to the first and sixth carbon (C1 and C6) of levoglucosan results in cleavage of the C1-oxygen bond and the addition of a water molecule to C1, which gives glucose in 100% conversion.

Key advantages associated with use of a solid acid (versus sulfuric or another liquid acid) to catalyze hydrolysis are that 1) like liquid acids, solid acid catalyzes hydrolysis reactions of anhydrosugars, 2) unlike liquid or soluble acids, solid acids are recovered simply by phase separation (decantation, filtation, centrifugation) and recycled, so that no base is required for acid neutralization, no waste salt is generated, and no acid is consumed, and 3) continuous flow reactors are feasible by using a fixed bed of the solid acid catalyst. Use of a solid acid for hydrolysis is feasible in this application because the anhydrosugar substrate is water-soluble, which ensures sufficient substrate-catalyst contact to effect hydrolysis. The preferred solid acid catalyst system for this application is a sulfonic acid-type resin (such as a strong acid ion exchange resin in an H+ form) or a Nafion® resin, and the hydrolysis reaction is carried out at a temperature range of 80°-125° C. The process is compatible with continuous process operation by passing the aqueous anhydrosugar fraction through a heated bed of the acid resin.

Several literature references showed that hydrolysis of esters with water could be conducted with solid acid catalysts (for example, see Kamiya, Y.; Sakata, S.; Yoshinaga, Y.; Ohnishi, R.; Okuhara, T. Catal. Letters 2004, 94, 45-47; Li, S. S.; Yoshinaga, Y.; Okuhara, T. Physical Chem. Chem. Physics 2002, 24, 6129-6136; Okuhara, T.; Kimura, M.; Kawai, T.; Nakato, T. Catalysis Today 1998, 45, 73-77; and Izumi, Y.; Urabe, K.; Onaka, M. Microporous & Mesoporous Mater. 1998, 21, 227-233, all of which are incorporated by reference herein). Prior literature shows very few examples of the use of solid acids for hydrolysis of carbohydrates, and these were only cases where the substrate for the hydrolysis was a natural soluble sugar or soluble starch. These include the following reports:

Solid acid catalysts were employed for catalyzing the hydrolysis of maltose and amylose starch (Abbadei, A.; Gotlieb, K. F.; van Bekkum, H. Starch/Starke 1998, 50, 23-28, which is incorporated by reference herein). The solid acid catalysts included strong acid cation exchange resins and a variety of zeolites (H-mordenite, H-beta, MCM41) and amorphous silicates (HA-SHPV and LA-SHPV) at temperatures of 120-130° C. Conversions of these soluble substrates were 45 to 85% in batch reaction periods of 24 hrs.

Hydrolysis of sucrose was also carried out with dealuminated Y-zeolite solid acid catalysts at temperatures of 30-70° C. (Buttersak, C.; Laketic, D. J. Molecular Catal. 1994, 94, L283-L290, which is incorporated by reference herein). Sucrose conversions up to 90% at the higher temperature were reported.

There is no known prior art wherein a liquid or solid acid-catalyzed hydrolysis is effectively integrated with a process beginning with a solid biomass, proceeding through a pyrolysis and separation to produce an anhydrosugar stream with low inhibitor concentrations and finally ending with a substrate suitable for efficient yeast fermentation.

Typically higher temperatures increase reaction rates and conversions, and this is especially important for reactions that occur on the liquid-solid interface where diffusion is extremely important in determining the overall rate. Thus, at least 70° C. is preferred for the hydrolysis reactions of the anhydrosugar constituents. There are two types of factors that determine the upper temperature limit. First is the instability of the catalyst. The sulfonic acid type catalysts are somewhat unstable at the higher temperatures (120° C.). Many of the inorganic or silicate type catalysts are however stable at this temperature. Second is the potential for acid-catalyzed dehydration reactions of the carbohydrates at higher temperatures. For example, glucose is readily converted to hydroxyfurfural and other byproducts at 150° C. in the presence of an aluminosilicate catalyst (Lourvanij, K.; Rorrer, G. L. J. Chem. Tech. Biotech. 1997, 69, 35-44, which is incorporated by reference herein).

### BRIEF DESCRIPTION OF THE DRAWINGS

The present invention is illustrated by way of example and not limitation in the figures of the accompanying drawings, in which like references indicate similar elements and in which:

FIG. 1 is a diagram illustrating the acid-catalyzed hydrolysis of levogluconsan to glucose.

FIG. 2 is a simplified thermal process flow diagram.

FIG. 3 is a table (Table 1) illustrating the composition of cold water extract to bio-oil.

FIG. 4 is a table (Table 2) illustrating the continuous-process hydrolysis of cold water extract to bio-oil.

FIG. 5 is a table (Table 3) illustrating the batch hydrolysis of cold water extract.

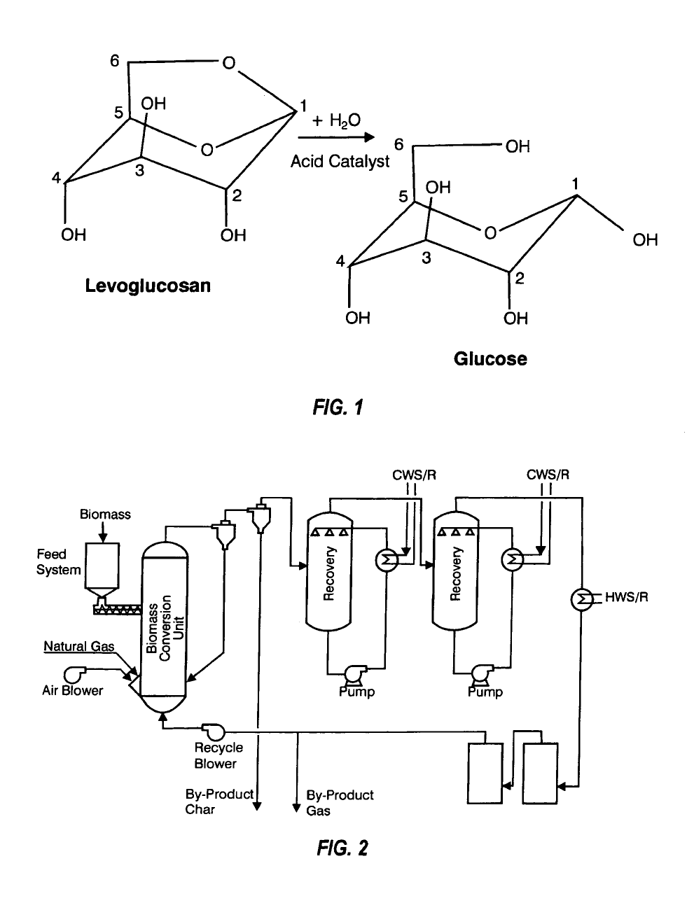

### DETAILED DESCRIPTION

This invention is a method for the production of glucose and other fermentable sugars from a fast-pyrolysis bio-oil fraction or other anhydrosugar-containing feedstock. One example of the invention includes the steps of:
1) Water extraction of an anhydrosugar-containing feedstock at ambient conditions.
2) Hydrolysis of the water extract using the following materials, proportions, and reaction conditions as described above.

Following is an outline of various examples of features of the invention.
A) Examples of materials, proportions, and reaction conditions that have demonstrated desired results
   1) RTP™-generated bio-oil as feedstock
      Bio-oils generated via pyrolysis of paper, cardboard, straw, stover, grass, pulp, and other lignocellulosic materials
      Bio-oils fractionated by distillative method
   2) Initial purification conditions
      Water-bio-oil volumetric ratio for water extraction—1:1 to 10:1
      Water extraction temperature—55° to 80° F.
      Water extract filtration temperature—55° to 80° F.
   3) Solid acid hydrolysis conditions
      Hydrolysis catalyst type—sulfonic acid-type resin (such as a strong acid ion exchange resin in an H+ form)
      Hydrolysis reactor configuration—continuous reactor with bed of extruded pellets or batch reaction in pressurized autoclave reactor
      Hydrolysis temperature—80° to 130° C.

As a first example of the present invention, glucose production from fast pyrolysis-derived bio-oil in continuous reactor is described below.

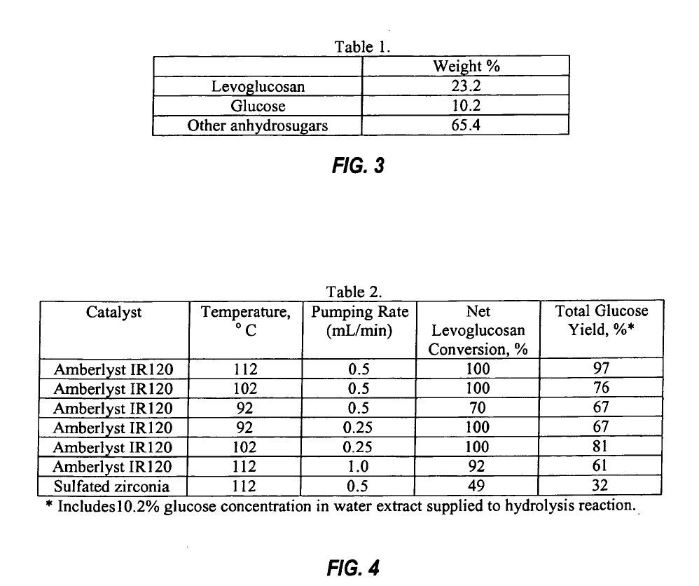

A wood-derived, RTP™-generated condensate product was distilled to remove volatile aldehydes and acids as described in U.S. Pat. No. 5,393,542 (incorporated by reference herein). The resulting high carbohydrate residual oil was extracted with cold water using a volume to oil ratio=10, which yielded a water extract that comprised 47% of the as-received bio-oil condensate product. The water extract was analyzed by high-performance liquid chromatography using an Biorad Aminex HPX87 column and water eluent at a flow rate of 1.2 ml/min and refractive index detector (Waters). Table 1 (FIG. 3) displays a compositional analysis of the water extract. The aqueous solution was extracted with diethyl ether three times to remove phenolic and catecholic species, and reanalyzed by HPLC.

The water extract was subjected to a series of solid acid-catalyzed hydrolysis reactions in both batch and continuous-process modes. Table 2 (FIG. 4) shows levoglucosan conversion and glucose yield achieved using different catalysts and reaction conditions in a continuous-process reaction configuration that comprised pump-driven flow of water extract through a heated column containing a catalyst bed. All data points provided in Table 2 have been confirmed by replication in at least three separate experiments.

The conversion-yield data is obtained via simplified assumptions based on the limitations listed here. Not only is levoglucosan hydrolyzed to glucose, it is also formed as a product of hydrolysis of anhydrooligosaccharides. Glucose forms both from levoglucosan hydrolysis and anhydrooligosaccharide hydrolysis. None of the structures of anhydrooligosaccharides are known, and so none of the amounts of these are known with any certainty. Thus, the reported % conversion of levoglucosan is net conversion or the initial concentration minus the final concentration times 100 divided by the initial concentration. The glucose % yield is the final glucose concentration times 100 divided by the concentration of glucose after complete hydrolysis (the initial glucose is not subtracted).

As shown, excellent levoglucosan conversion and glucose yield were achieved at 112° C. and a flow rate of 0.5 milliliters per minute (mL/min), while conversions and glucose yields at lower temperatures were considerably reduced. The data show the importance of not assuming a direct and consistent relationship between levoglucosan conversion and glucose yield. For example, when reaction time was increased at 92° C. by slowing the pumping rate from 0.5 to 0.25 mL/min, levoglucosan conversion increased to 100%, but glucose yield remained at 67%. This seeming incongruity is likely a result of an increased level of incomplete conversion of di- and oligosaccharides (to glucose) accompanying the observed increase in levoglucosan conversion.

Another example of the present invention, the batch reactions of bio-oil extract with solid acid catalysts is described below.

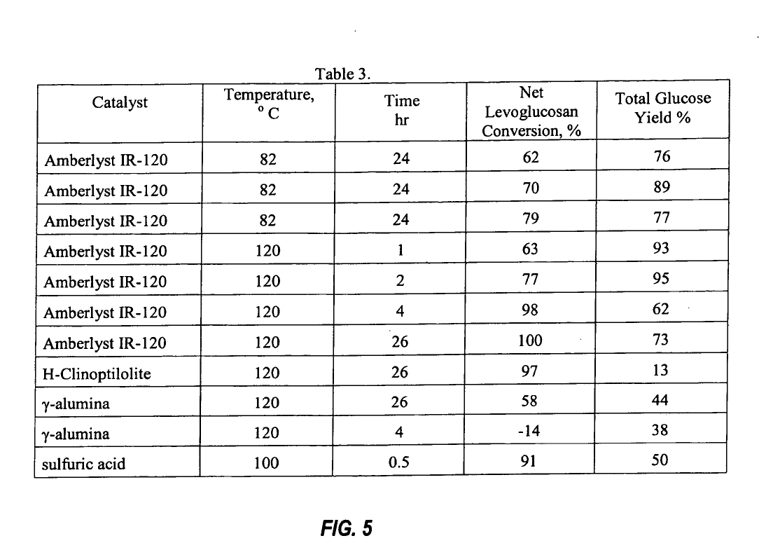

Batch reactions were conducted on the aqueous extract of the bio-oil in a 300 mL stirred Parr reactor, with the objective of comparing the hydrolyzing efficiency of two solid acid catalysts with that of liquid sulfuric acid. After adding the aqueous extract (200 mL) to the desired catalyst (5 g) in the reactor, the reactor was sealed and pressurized with 200 psi of nitrogen, The reactor was then heated to the desired temperature for the desired reaction period. When the reactor cooled, it was depressurized, opened, and the contents analyzed for reactant sugars and products by HPLC. Several repetitions were performed for some of the catalysts at various temperatures. Sulfuric acid was also used for comparative purpose. Results are summarized in FIG. 5 (Table 3).

From the batch data, it is clear that very good conversions of levoglucosan can be obtained from the RTP product with solid acid catalysts at temperatures of 120° C., provided the reaction time is longer than 2 hours. Total glucose yields from hydrolysis of anhydrooligosaccharides are also high under these conditions for some of the catalysts, but not for others. Short time reaction periods showed negative conversions for levoglucosan for alumina catalyst, owing to the formation being fast, but overall yields of glucose remained low. The soluble liquid acid, sulfuric acid, which was run for comparative purpose showed mediocre yields over short reaction times. A fermentability test with Saccharomyces demonstrated that 90% of the glucose in the hydrolyzed product was converted to ethanol.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. Method to produce fermentable sugars from a ligno-cellulosic substrate using a solid acid catalyst whereby the ligno-cellulosic substrate is treated by rapid thermal pyrolysis to produce anhydrosugars that are hydrolyzed to fermentable sugars.

2. The method as in claim 1, wherein the rapid thermal pyrolysis is run under conditions that minimize the amount of fermentation inhibitors appearing in the fermentable sugars obtained downstream from the pyrolysis process.

3. The method as in claim 2, wherein the rapid thermal pyrolysis product stream is processed using a separation process that minimizes the inhibitors appearing in the fermentable sugars obtained downstream from the pyrolysis process.

4. The method as in claim 1, wherein the solid acid catalyst is a strong cation exchange resin (Hydrogen form).

5. The method as in claim 1, wherein the solid acid catalyst is gamma alumina.

6. The method as in claim 1, wherein the solid acid catalyst is a zeolite in hydrogen form.

7. The method as in claim 1, wherein the solid acid catalyst is sulfated zirconia.

8. The method as in claim 1, wherein the hydrolysis temperature is 80° to 130° C.

9. The method as in claim 3, wherein the inhibitors are removed by a distillation step.

10. The method as in claim 3, wherein the inhibitors and other resinous products are separated from the carbohydrate fraction by a water extraction step.

11. The method as in claim 3, wherein the extraction temperature is 13° to 100° C.

12. The method as in claim 3, wherein the inhibitors are removed by a solvent extraction step.

13. The method as in claim 2, wherein the rapid thermal pyrolysis is conducted with a circulating hot particulate medium.

14. The method as in claim 12, wherein the biomass source is paper, wood (sawdust), straw, pulp, stover, or grass.
